(19) United States
(12) Patent Application Publication
(10) Pub. No.: US 2023/0014277 A1
(43) Pub. Date: Jan. 19, 2023

(54) LIGHT INSPECTION METHOD AND DEVICE FOR QUANTITATIVE ANALYSIS ON FILLING LEVEL OF VAPOR PRODUCING SECTION OF AEROSOL GENERATING PRODUCT

(71) Applicant: YUNNAN XIKE SCIENCE & TECHNOLOGY CO., LTD., Kunming (CN)

(72) Inventors: Yun DAI, Kunming (CN); Ningning YAN, Kunming (CN); Wenyan ZHAO, Kunming (CN); Yong ZHANG, Kunming (CN); Zheng CHEN, Kunming (CN); Zhennan HUANG, Kunming (CN); Yuefeng CHEN, Kunming (CN); Shenghong YUAN, Kunming (CN)

(73) Assignee: YUNNAN XIKE SCIENCE & TECHNOLOGY CO., LTD., Kunming (CN)

(21) Appl. No.: 17/783,273

(22) PCT Filed: Oct. 21, 2020
(86) PCT No.: PCT/CN2020/122513

§ 371 Date: Jun. 8, 2022

(30) Foreign Application Priority Data
Sep. 11, 2020 (CN) 202010954898.1

(51) Int. Cl. G01F 23/292; G01N 21/53

(52) U.S. Cl. CPC G01F 23/292; G01N 21/53

(57) ABSTRACT

A light inspection method for a quantitative analysis on a filling level of a vapor producing section of an aerosol generating product is provided. The light inspection method includes: providing a light inspection device for holding an aerosol generating product and a surface light source for emitting a horizontal beam; and an angle between an axis of the aerosol generating product held by the light inspection device and a horizontal plane is 0-90°; the axis of the aerosol generating product held by the light inspection device is perpendicular to the horizontal beam emitted by surface light source. A light inspection device for a quantitative analysis on a filling level of a vapor producing section of an aerosol generating product is further provided. The light inspection device can accurately detect the filling level of a vapor producing section of an aerosol generating product.

### CROSS REFERENCE TO THE RELATED APPLICATIONS

This application is the national phase entry of International Application No. PCT/CN2020/122513, filed on Oct. 21, 2020, which is based upon and claims priority to Chinese Patent Application No. 202010954898.1, filed on Sep. 11, 2020, the entire contents of which are incorporated herein by reference.

### TECHNICAL FIELD

The present disclosure relates to the technical field of production of heat-not-burn (HBN) products, and in particular to a light inspection method and device for a quantitative analysis on a filling level of a vapor producing section of an aerosol generating product.

### BACKGROUND

The vapor producing sections of the aerosol generating products currently available on the market mainly adopt granular, shredded, flaky and pasty vapor producing materials as the aerosol generating source. The aerosol generating products are a new type of tobacco products with their appearance structure, forming process and vapor producing mechanism different from those of traditional cigarettes. Due to the special properties of the aerosol generating products, there are currently no clear standard requirements for the aerosol generating products, resulting in uneven quality of aerosol generating products on the market. In particular, there is a lack of inspection methods for the filling level of the granular and pasty vapor producing materials. The filling level of the aerosol generating source seriously affects the vapor producing effect of the aerosol generating product, thereby affecting the sensory smoking quality. In the prior art, the filling level of the aerosol generating product is mainly evaluated by weighing. However, the weight fluctuates significantly due to the complex structure and material composition of the aerosol generating product, and the manual weighing method has high labor intensity and low efficiency.

Light inspection is an important quality inspection method, which is mainly used in the inspection of ampoules, vials, and oral liquid bottles in the pharmaceutical, food, chemical, pesticide and other industries.

CN208969019U discloses a light inspection machine, including shock-absorbing support legs, a light inspection chamber provided on the shock-absorbing support legs, and a bearing device provided in the light inspection chamber. The bearing device includes a motor, a light inspection table, a connecting rod and a chuck. The motor is provided in the light inspection chamber and at the bottom of the light inspection chamber. A drive shaft of the motor is connected with a geometric center of the light inspection table. A central position of an upper surface of the light inspection table is provided with a first inspection light. A sample holding slot surrounding the first inspection light is provided outside the light inspection table. The bottom of the sample holding slot is provided with a second inspection light and a warning light. The connecting rod is provided on the light inspection table, and is provided with a cavity that runs through an entire rod body. A first spring is provided in the cavity of the connecting rod. The first spring has one end connected with the light inspection table and the other end connected with the chuck. The light inspection machine mainly solves the problems of unstable manual clamping and inspection blind spots.

CN208537445U discloses a horizontal light inspection box, including a vertical light inspection box provided longitudinally with a barrel conveying chain and electrically connected with a conveying chain motor, and a horizontal light inspection box provided in parallel with the barrel conveying chain. The horizontal light inspection box is fixedly connected with the vertical light inspection box. A fixing bracket is provided below the horizontal light inspection box, and is connected with the barrel conveying chain through a rotating rocking wheel, a telescopic screw and a locking screw which are connected by transmission. The vertical and horizontal light inspection boxes are provided with light-emitting diode (LED) parallel backlight sources, which are each provided with at least two barrel brackets.

CN203299141U discloses a light inspection machine, including a light inspection box with a light source inside. The light inspection box has a top provided with a transparent light inspection workbench and a side provided with a light blocking plate. The light blocking plate is connected with side panels of the light inspection workbench and the light inspection box. The light source is located below the light blocking plate.

To sum up, the existing light inspection devices are mainly designed to check whether there is a suspension in the liquid in the ampoule, vial or oral liquid bottle, and the light source is located directly under the inspection sample. The light emitted by the light source passes through the inspection sample, allowing the inspector to observe whether there are suspended impurities in the inspection sample.

The existing light inspection devices have a complicated structure and high cost, and can only inspect a small number of samples, failing to meet the needs of industrial production. In particular, the existing light inspection devices are not suitable for inspecting the filling level of the vapor producing section of the aerosol generating product. As shown in FIG. 1, an aerosol generating product is provided horizontally on an inspection plate, and a light source is located under the inspection plate and faces the aerosol generating product. The inspector observes from above the aerosol generating product whether the vapor producing section is fully filled with a vapor producing material. Taking vapor producing particles as an example, since the vapor producing particles are opaque to light, when their filling level in the vapor producing section is more than 50%, the inspector cannot see the light passing through the vapor producing particles. Even when the filling level is reduced to 25%, the inspector can only see a small amount of light at the edge of the vapor producing section. If the above method is used to detect the filling level of the vapor producing section of the aerosol generating product, it will directly lead to the following problems. 1. The inspection results are inaccurate, and only a vapor producing section with a filling level below 50% can be inspected. When the filling level is equal to or greater than 50%, what is seen in the eyes of the inspector is a fully filled vapor producing section. 2. The inspection of the vapor producing section with a filling level below 50% is qualitative, and the filling level cannot be determined quantitatively and accurately. 3. The inspector has high labor intensity and low inspection efficiency.

In addition, the thin, long and cylindrical aerosol generating product is easy to roll when provided horizontally and easy to slip when provided vertically. Therefore, it is necessary to manually hold the aerosol generating product for inspection, resulting in high labor intensity and low efficiency. To solve these problems, it is necessary to design a light inspection device for the filling level of the vapor producing section of the aerosol generating product based on the shape of the aerosol generating product and the special properties of the vapor producing material.

For this reason, the invention of present disclosure is proposed.

### SUMMARY

In order to solve the above problems, the present disclosure proposes a light inspection device for a filling level of a vapor producing section of an aerosol generating product. The present disclosure has the advantages of low cost, simple operation, high identification accuracy, batch inspection, and can accurately identify whether an aerosol generating source fully fills in a cavity, which is convenient for product inspection.

A first aspect of the present disclosure provides a light inspection method for a quantitative analysis on a filling level of a vapor producing section of an aerosol generating product, including: providing a light inspection device for holding an aerosol generating product and a surface light source for emitting a horizontal beam; and

an angle between an axis of the aerosol generating product held by the light inspection device and a horizontal plane is 0-90°; the axis of the aerosol generating product held by the light inspection device is perpendicular to the horizontal beam emitted by the surface light source.

Regarding the angle, a vertical line perpendicular to a plane is drawn through a point on a straight line that is not parallel to the plane, and a line connecting an intersection of the vertical line and the plane and an intersection of the straight line and the plane forms an acute angle or a right angle.

A second aspect of the present disclosure provides a light inspection device for a quantitative analysis on a filling level of a vapor producing section of an aerosol generating product, including a surface light source and a light inspection box, where

the light inspection box includes a casing, multiple baffles inside the casing, and multiple sample holding slots divided by the multiple baffles; and the sample holding slots hold aerosol generating products with a vapor producing section filled with a vapor producing particle or a vapor producing paste;

the surface light source emits a horizontal beam that passes through the aerosol generating product held in the light inspection box;

an axis of the aerosol generating product forms an angle of 0-90° with a horizontal plane, and is perpendicular to the horizontal beam emitted by the surface light source; and

the light inspection box further includes an outer cover located outside the sample holding slot to prevent the aerosol generating product held in the sample holding slot from falling off; and the outer cover is made of a light-transmitting material, selected from either transparent glass or transparent plastic, such that the aerosol generating product in the light inspection box can be observed after the outer cover is closed.

Preferably, the casing may be made of a light-transmitting material, selected from either transparent glass or transparent plastic, such that the horizontal beam passes through the casing to the aerosol generating product.

Preferably, the baffles may be made of an opaque material, selected from brown glass or dark plastic or metal or ceramic, etc. That is to say, the other part of the light inspection box apart from the aerosol generating product is opaque to prevent the horizontal beam emitted by the surface light source from irritating the eyes of an inspector.

Preferably, the sample holding slots each may be matched with dimensions of a single or multiple parallel aerosol generating products to hold the aerosol generating product. That is to say, the length, width and depth of the sample holding slot are just to hold the aerosol generating product to be inspected, or the length, width and depth of the sample holding slot are just to hold multiple sequentially arranged aerosol generating products to be inspected. The baffles forming the sample holding slots may be arranged horizontally or vertically.

Preferably, the surface light source may be a light-emitting diode (LED) diffuser panel. The light source is evenly distributed in breadth, has no flicker, and has stable color temperature. The brightness can be adjusted at will through an external regulator, which reduces the fatigue of the inspector and improves the inspection efficiency.

Preferably, the casing may be provided with scales.

A third aspect of the present disclosure provides a light inspection method for a quantitative analysis on a filling level of a vapor producing section of an aerosol generating product by using the above light inspection device, including the following steps:

(1) holding an aerosol generating product to be inspected into the sample holding slot, providing the light inspection box in front of a surface light source, and an angle between an axis of the aerosol generating product and a horizontal plane is 0-90°, and the axis of the aerosol generating product is perpendicular to a horizontal beam emitted by the surface light source; and

(2) turning on the surface light source, such that the horizontal beam emitted by the surface light source passes through the aerosol generating product held in the light inspection box; and calculating, according to a ratio of a shadow area of an opaque part in the vapor producing section of the aerosol generating product to a shadow area of the vapor producing section, a filling level of the vapor producing section;

filling level=shadow area of the opaque part in the vapor producing section/shadow area of the vapor producing section*100%.

An inspector faces the surface light source and is located in front of the light inspection box. The part of the light inspection box that does not hold the aerosol generating product is opaque to prevent the horizontal beam emitted by the surface light source from irritating the eyes of the inspector. In addition, the filling level can also be calculated by analyzing a picture taken by a camera.

Preferably, the casing may be provided with different scales to indicate different filling levels of the vapor producing section, and the filling level of the vapor producing section may be determined by a scale corresponding to a horizontal plane of the opaque part in the vapor producing section and the angle between the axis of the aerosol generating product and the horizontal plane.

The aerosol generating source herein refers to a vapor producing particle or a vapor producing paste filled in the vapor producing section of the aerosol generating product.

Compared with the prior art, the present disclosure has the following beneficial effects.

1. Based on the shape of the aerosol generating product and the special properties of the vapor producing material, the present disclosure designs a light inspection device for the filling level of the vapor producing section of the aerosol generating product for the first time. The present disclosure can accurately determine whether the aerosol generating source fully fills in the cavity and quantitatively determine the filling level, which is convenient for product inspection. The present disclosure solves the problem that the prior art cannot accurately detect an aerosol generating product filled with an insufficient aerosol generating source or zero aerosol generating source.

2. In the light inspection device of the present disclosure, the light inspection box can flexibly design the inspection quantity according to the actual demand. The dimensions of the light inspection box can be customized, which can realize batch product inspection, and the casing and the baffles are detachably provided, which is convenient for operation. In addition, the sample holding slots each are matched with dimensions of a single or multiple parallel aerosol generating products to hold the aerosol generating product. That is to say, the length, width and depth of the sample holding slot are just to hold the aerosol generating product to be inspected, or the length, width and depth of the sample holding slot are just to hold multiple sequentially arranged aerosol generating products to be inspected. In this way, the aerosol generating product can be neatly held in the sample holding slot of the light inspection box provided horizontally or vertically, avoiding manual handling of the sample to be inspected, saving labor and improving inspection efficiency.

3. The light inspection device of the present disclosure perfectly solves the problem that the existing light inspection device cannot accurately detect the aerosol generating product with a filling level equal to or greater than 50%. The light inspection device of the present disclosure can accurately detect the vapor producing section of an aerosol generating product with any filling level. It is simple to operate, and greatly improves inspection efficiency and light inspection accuracy (up to 100%).

4. In the preferred embodiment of the present disclosure, the casing of the light inspection box is provided with different scales matched with different filling levels of the vapor producing section. The filling level of the vapor producing section is determined by the scale corresponding to the horizontal plane of the opaque part in the vapor producing section. When the light inspection box is provided at a certain angle with the horizontal plane, the filling level of the vapor producing section is determined by the scale corresponding to the horizontal plane of the opaque part in the vapor producing section and the angle. That is to say, the light inspection method of the present disclosure can qualitatively identify whether the aerosol generating source fully fills in the cavity, and can also simply and quantitatively determine the filling level of the aerosol generating source.

5. In the light inspection device of the present disclosure, the baffles are made of an opaque material, and the sample holding slots are formed to hold the aerosol generating product to be inspected. The baffles can also prevent the horizontal beam emitted by the surface light source from irritating the eyes of the inspector, thereby reducing the fatigue of the inspector.

6. Compared with the current evaluation of the filling level of the aerosol generating product by weighing, the light inspection device in the present disclosure has the advantages of low labor intensity, high accuracy and high efficiency.

7. In the light inspection device of the present disclosure, the surface light source is a light-emitting diode (LED) diffuser panel. The light source is evenly distributed in breadth, has no flicker, and has stable color temperature. The brightness can be adjusted at will through an external regulator, which reduces the fatigue of the inspector and improves the inspection efficiency.

### BRIEF DESCRIPTION OF THE DRAWINGS

FIG. 1 is a schematic view of a light inspection device during inspection of an aerosol generating product in the prior art;

FIG. 2 is a schematic view of a light inspection device during inspection of an aerosol generating product according to Embodiment 1 of the present disclosure;

FIG. 3 is a schematic view of the light inspection device during inspection of an aerosol generating product according to Embodiment 2 of the present disclosure;

FIG. 4 is a schematic view of a light inspection box 2 during inspection according to Embodiment 1 of the present disclosure;

FIG. 5 is a schematic view of the light inspection box 2 during inspection according to Embodiment 2 of the present disclosure; and

FIG. 6 is a schematic view of the light inspection box 2 during inspection according to Embodiment 3 of the present disclosure.

### REFERENCE NUMERALS

1. surface light source; 2. light inspection box; 3. aerosol generating product; 21. casing; 22. baffle; 23. sample holding slot; 31. vapor producing section; 32. blocking member; 33. filtering section; and 34. empty section.

### DETAILED DESCRIPTION OF THE EMBODIMENTS

The present disclosure will be further described in detail below with reference to the embodiments and drawings. The embodiments are used only to describe the present disclosure, rather than to limit the present disclosure.

In the following embodiments, the aerosol generating source adopts a vapor producing particle, and the inspection device and method are also applicable to a vapor producing paste.

The aerosol generating product 3 includes a vapor producing section 31, a blocking member 32, an empty section 34 and a filtering section 33.

### Embodiment 1

This embodiment provides a light inspection method for a quantitative analysis on a filling level of a vapor producing section of an aerosol generating product, including the following steps:

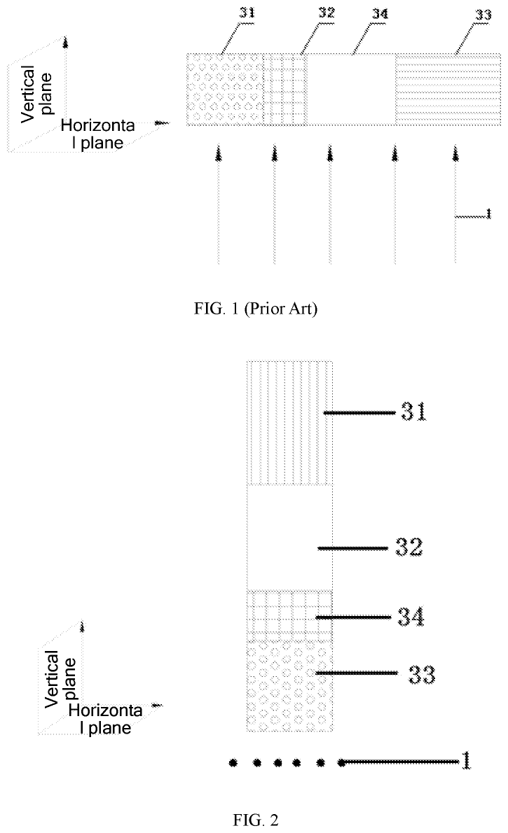

(1) An aerosol generating product to be inspected is held into a sample holding slot 23, and a light inspection box 2 is provided in front of a surface light source 1. An angle between an axis of the aerosol generating product and a horizontal plane is 90°, and the axis of the aerosol generating product is perpendicular to a horizontal beam emitted by the surface light source 1, as shown in FIGS. 2 and 4.

(2) The surface light source 1 is turned on, such that the horizontal beam emitted by the surface light source 1 passes through the aerosol generating product held in the light inspection box 2. According to a ratio of a shadow area of an opaque part in the vapor producing section of the aerosol generating product to a shadow area of the vapor producing section, the filling level of the vapor producing section is calculated;

filling level=shadow area of the opaque part in the vapor producing section/shadow area of the vapor producing section*100%.

Further, a casing 21 is provided with different scales to indicate different filling levels of the vapor producing section, and the filling level of the vapor producing section is determined by a scale corresponding to a horizontal plane of the opaque part in the vapor producing section.

Intuitively, as shown in FIG. 4, the horizontal beam emitted by the surface light source 1 is from the inside of the paper to the outside of the paper, so the inspector observes the aerosol generating product in the light inspection box 2 from the outside of the paper and perpendicular to the paper.

A first batch of 12 aerosol generating products was inspected by using the above device. In order to clearly show the structure of the light inspection box 2, FIG. 4 only shows a sample 1-1 (a first sample from top to bottom in a first column, the same below), a sample 1-2 (a second sample from top to bottom in the first column), a sample 2-1 (a first sample from top to bottom in a second column), and a sample 2-2 (a second sample from top to bottom in the second column). It can be seen from FIG. 4 that in the first batch of samples, except for the sample 1-1, the vapor producing sections 31 of other aerosol generating products are fully filled, with a filling level of 100%. According to the scale on the casing 21 of the light inspection box 2, the filling level of the sample 1-1 is accurately 80%.

### Embodiment 2

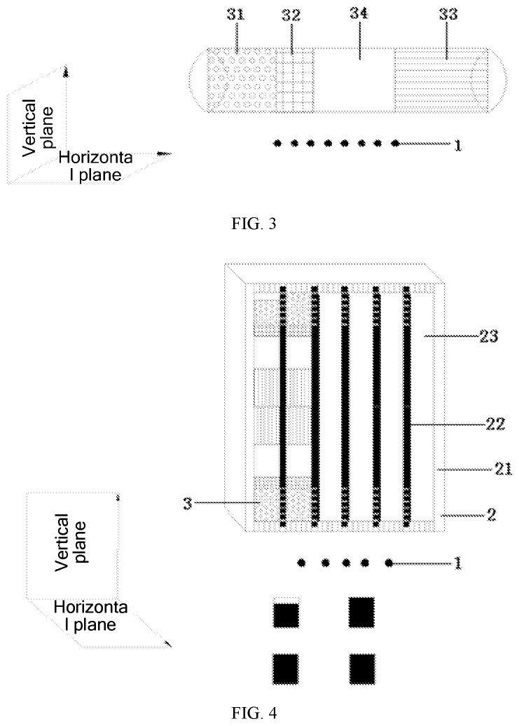

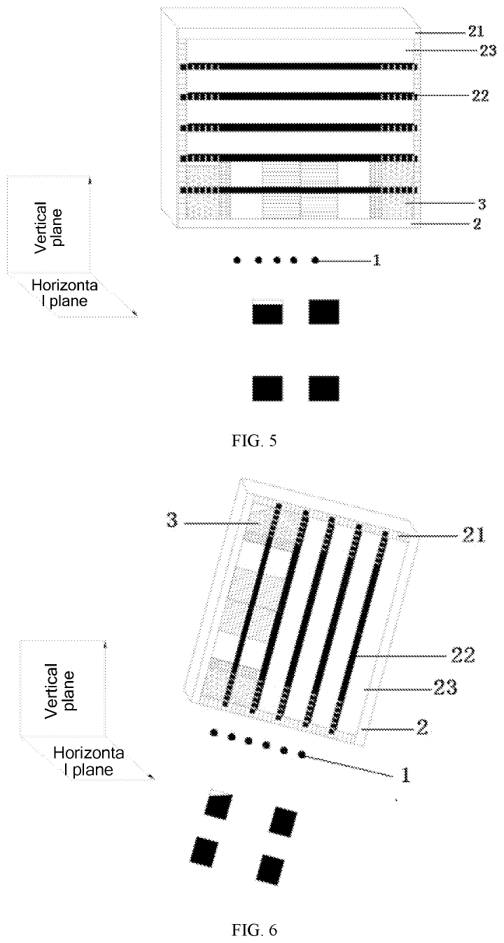

The light inspection method adopted in this embodiment is the same as that in Embodiment 1, with the following differences: the angle between the axis of the aerosol generating product 3 held in the light inspection box 2 and the horizontal plane is 0°, the horizontal beam emitted by the surface light source 1 passes through the aerosol generating product 3, and the axis of the aerosol generating product is perpendicular to the horizontal beam emitted by the surface light source 1, as shown in FIG. 3. That is, on the basis of Embodiment 1, the light inspection box 2 is directly rotated by 90°, as shown in FIG. 5.

Intuitively, the same as FIG. 4, as shown in FIG. 5, the horizontal beam emitted by the surface light source 1 is from the inside of the paper to the outside of the paper, so the inspector observes the aerosol generating product in the light inspection box 2 from the outside of the paper and perpendicular to the paper.

A second batch of 12 aerosol generating products was inspected by using the above device. In order to clearly show the structure of the light inspection box 2, FIG. 5 only shows a sample 1-1 (a first sample from left in a first row, the same below), a sample 1-2 (a second sample from left in the first row), a sample 2-1 (a first sample from left in a second row), and a sample 2-2 (a second sample from left in the second row). It can be seen from FIG. 5 that in the second batch of samples, except for the sample 1-1, the vapor producing sections 31 of other aerosol generating products are fully filled, with a filling level of 100%. According to the scale on the casing 21 of the light inspection box 2, the filling level of the sample 1-1 is accurately 80%.

### Embodiment 3

The light inspection method adopted in this embodiment is the same as that in Embodiment 1, with the following differences: the angle between the axis of the aerosol generating product 3 held in the light inspection box 2 and the horizontal plane is 60°, the horizontal beam emitted by the surface light source 1 passes through the aerosol generating product 3, and the axis of the aerosol generating product is perpendicular to the horizontal beam emitted by the surface light source 1. That is, on the basis of Embodiment 1, the light inspection box 2 is directly rotated by 30°, as shown in FIG. 6.

Intuitively, the same as FIG. 4, as shown in FIG. 6, the horizontal beam emitted by the surface light source 1 is from the inside of the paper to the outside of the paper, so the inspector observes the aerosol generating product in the light inspection box 2 from the outside of the paper and perpendicular to the paper.

A third batch of 12 aerosol generating products was inspected by using the above device. In order to clearly show the structure of the light inspection box 2, FIG. 6 only shows a sample 1-1 (a first sample from top to bottom in a first column, the same below), a sample 1-2 (a second sample from top to bottom in the first column), a sample 2-1 (a first sample from top to bottom in a second column), and a sample 2-2 (a second sample from top to bottom in the second column). It can be seen from FIG. 6 that in the third batch of samples, except for the sample 1-1, the vapor producing sections 31 of other aerosol generating products are fully filled, with a filling level of 100%. According to the shadow area, the filling level of the sample 1-1 is calculated as 80%.

What is claimed is:

1. A light inspection method for a quantitative analysis on a filling level of a vapor producing section of an aerosol generating product, comprising: providing a light inspection device for holding the aerosol generating product and providing a surface light source for emitting a horizontal beam; and
adjusting an angle between an axis of the aerosol generating product held by the light inspection device and a horizontal plane to be 0-90°; adjusting the axis of the aerosol generating product held by the light inspection device to be perpendicular to the horizontal beam emitted by the surface light source.

2. A light inspection device for a quantitative analysis on a filling level of a vapor producing section of an aerosol generating product, comprising a surface light source and a light inspection box, wherein
the light inspection box comprises a casing, a plurality of baffles inside the casing, and a plurality of sample holding slots divided by the plurality of baffles; and the plurality of sample holding slots hold the aerosol generating product with the vapor producing section filled with a vapor producing particle or a vapor producing paste;
the surface light source emits a horizontal beam, the horizontal beam passes through the aerosol generating product held in the light inspection box;
an axis of the aerosol generating product forms an angle of 0-90° with a horizontal plane, and the axis of the aerosol generating product is perpendicular to the horizontal beam emitted by the surface light source.

3. The light inspection device according to claim 2, wherein the casing is made of a light-transmitting material, the light-transmitting material is one selected from the group consisting of transparent glass and transparent plastic.

4. The light inspection device according to claim 2, wherein the plurality of baffles are made of an opaque material.

5. The light inspection device according to claim 2, wherein the plurality of sample holding slots each are matched with a dimension of a single aerosol generating product or a dimension of a plurality of parallel aerosol generating products to hold the single aerosol generating product or the plurality of parallel aerosol generating products.

6. The light inspection device according to claim 2, wherein the surface light source is a light-emitting diode (LED) diffuser panel.

7. The light inspection device according to claim 2, wherein the casing is provided with scales.

8. A light inspection method for a quantitative analysis on a filling level of a vapor producing section of an aerosol generating product by using the light inspection device according to claim 2, comprising the following steps:
holding the aerosol generating product to be inspected into the sample holding slot, providing the light inspection box in front of the surface light source, and adjusting the angle between the axis of the aerosol generating product and the horizontal plane to be 0-90°, and adjusting the axis of the aerosol generating product to be perpendicular to the horizontal beam emitted by the surface light source; and
turning on the surface light source, wherein the horizontal beam emitted by the surface light source passes through the aerosol generating product held in the light inspection box; and calculating, according to a ratio of a shadow area of an opaque part in the vapor producing section of the aerosol generating product to a shadow area of the vapor producing section, the filling level of the vapor producing section; wherein
the filling level=the shadow area of the opaque part in the vapor producing section/the shadow area of the vapor producing section*100%.

9. The light inspection method according to claim 8, further comprising: determining the filling level of the vapor producing section by a scale corresponding to a horizontal plane of the opaque part in the vapor producing section and the angle between the axis of the aerosol generating product and the horizontal plane, wherein the casing is provided with different scales to indicate different filling levels of the vapor producing section.
